(19) United States
(12) Patent Application Publication
(10) Pub. No.: US 2025/0015351 A1
(43) Pub. Date: Jan. 9, 2025

(54) ELECTROLYTE FOR LITHIUM METAL BATTERY AND LITHIUM METAL BATTERY INCLUDING SAME

(71) Applicant: SEOUL NATIONAL UNIVERSITY R&DB FOUNDATION, Seoul (KR)

(72) Inventors: Jang Wook Choi, Seoul (KR); Dong Joo Yoo, Gyeonggi-do (KR)

(21) Appl. No.: 18/502,357

(22) PCT Filed: Apr. 26, 2022
(86) PCT No.: PCT/KR2022/005899

§ 371 Date: Nov. 6, 2023

(30) Foreign Application Priority Data
May 11, 2021 (KR) 10-2021-0060670

(51) Int. Cl. H01M 10/0567; H01M 4/38; H01M 10/052; H01M 10/0568; H01M 10/0569; H01M 50/571

(52) U.S. Cl. CPC H01M 10/0567; H01M 4/382; H01M 10/052; H01M 10/0568; H01M 10/0569; H01M 50/571; H01M 2300/008

(57) ABSTRACT

The present disclosure provides an electrolyte for a lithium metal battery, containing a lithium salt, a solvent and a diluent including 1,2-difluorobenzene, wherein the lithium salt comprises one or more selected from the group consisting of lithium bis(fluorosulfonyl)imide (LiFSI), lithium bis(trifluoromethanesulfonyl)imide (LiTFSI), and lithium hexafluorophosphate (LiPF₆), the solvent comprises one or more selected from the group consisting of dimethyl carbonate (DMC), diethyl carbonate (DEC), ethyl methyl carbonate (EMC), ethylene carbonate (EC), and propylene carbonate (PC).

### TECHNICAL FIELD

The present disclosure relates to an electrolyte for a lithium metal battery and a lithium metal battery including the same, more particularly to an electrolyte for a lithium metal battery capable of preventing lithium dendrite formation in a lithium metal anode and a lithium metal battery including the same.

### BACKGROUND ART

Since the first commercialization in 1991, lithium-ion batteries have played key roles in the rapid development of mobile electronics including mobile phones and laptop computers and the recent emergence of electric vehicles.

Although lithium-ion batteries are stable because they use intercalation-based electrode materials, there are significant limitations in electrode capacity. Recently, with the rapid increase of energy density required for batteries, the development of new batteries with higher energy densities exceeding those of lithium-ion batteries is becoming urgent.

In this regard, lithium metal batteries using lithium metal as an anode are receiving attentions. The currently commercialized lithium-ion battery anode is made of a graphite material and has a theoretical capacity of 372 mAh/g. But, lithium metal has a theoretical capacity of 3,860 mAh/g, which is more than 10 times that of graphite, and it also has the lowest electrochemical potential of −3.040 V versus the standard hydrogen electrode (SHE) and a low density of 0.534 g/cm³. Therefore, lithium metal has a great potential as an anode.

However, the formation of sharp dendrites on the surface of the lithium metal anode remains as a major challenge in securing stability against the internal short circuit of batteries. In addition, the problem of low coulombic efficiency should be overcome.

### DISCLOSURE OF THE INVENTION

### Technical Problem

The present disclosure is directed to providing an electrolyte for a lithium metal battery that can prevent dendrite by forming a LiF-rich solid-electrolyte interphase on the surface of a lithium metal anode.

The present disclosure is also directed to providing a lithium metal battery with superior high voltage and cycle characteristics and improved stability, which includes the electrolyte for a lithium metal battery.

### Technical Solution

The present disclosure provides an electrolyte for a lithium metal battery equipped with a lithium metal anode, which contains: a lithium salt; a solvent; and a diluent including 1,2-difluorobenzene.

In an exemplary embodiment of the present disclosure, the lithium salt may include one or more selected from a group consisting of lithium bis(fluorosulfonyl)imide (LiFSI), lithium bis(trifluoromethanesulfonyl)imide (LiTFSI) and lithium hexafluorophosphate (LiPF₆).

In an exemplary embodiment of the present disclosure, the concentration of the lithium salt may be 0.5-5.5 M.

In an exemplary embodiment of the present disclosure, the solvent may include one or more selected from a group consisting of dimethyl carbonate (DMC), diethyl carbonate (DEC), ethyl methyl carbonate (EMC), ethylene carbonate (EC) and propylene carbonate (PC).

In an exemplary embodiment of the present disclosure, the concentration of the diluent may be 30-70 vol %.

In an exemplary embodiment of the present disclosure, the diluent may form a solid-electrolyte interphase predominantly containing lithium fluoride (LiF) on the surface of the lithium metal anode.

In an exemplary embodiment of the present disclosure, the diluent may form a local area of high concentration of lithium ions contained in the electrolyte.

The present disclosure also provides a lithium metal battery including: a cathode; a lithium metal anode; and the electrolyte for a lithium metal battery described above.

In an exemplary embodiment of the present disclosure, the cathode may further include a current collector, and the electrolyte may prevent the corrosion of the current collector by forming a solid-electrolyte interphase on the surface of the current collector.

### Advantageous Effects

In the present disclosure, 1,2-difluorobenzene is used as a dilution solvent to provide a local high concentration effect of lithium ions. Through this, the decomposition of anions contained in lithium salts can be accelerated and, accordingly, the lithium metal interface can be stabilized by preventing dendrite formation on the surface of lithium metal.

In addition, the use of 1,2-difluorobenzene as the dilution solvent can significantly improve the performance of a lithium metal battery by forming a LiF-rich solid-electrolyte interphase on the surface of lithium metal.

### BRIEF DESCRIPTION OF THE DRAWINGS

FIG. 1 shows the formation of SEIs in the present disclosure and the prior art.

FIGS. 2 and 3 show LUMO energy levels.

FIG. 4 shows the SEM images of Li metal after immersion in (a) BTFE, (b) Ben, (c) fBen, (d) 1,3-dfBen, (e) mBen, (f) tfmBen and (g) tfTol for 1 day.

FIG. 5 shows the SEM image of Li metal after immersion in 1,2-dfBen for 1 day and its EDS mapping images with respect to carbon and fluorine. The insert is a digital photograph of the same Li metal foil.

FIG. 6 shows the XPS spectra of Li metal after immersion in 1,2-dfBen for 1 day.

FIG. 7 shows the SEM image of Li metal after immersion in 2 M-DMC/1,2-dfBen for 1 day.

FIG. 8 shows the free energy of 1,2-dfBen and 1,3-dfBen during reaction.

FIGS. 9-11 show binding energy with lithium ions.

FIG. 12 shows Raman spectra depending on concentration.

FIG. 13 shows the Raman spectra BTFE, 2 M-DMC/BTFE, 1,2-dfBen and 2 M-DMC/1,2-dfBen.

FIG. 14 shows the cycling performance of Li—Cu asymmetric cells using different electrolytes with a capacity of 0.5 mAh cm⁻² at current densities of (a) 0.5 mA cm⁻² and (b) 0.5, 1, 2, 5 and 10 mA cm⁻².

FIG. 15 shows the cycling performance of Li—Cu asymmetric cells with different electrolytes (a) 2 M-DMC/mBen, DMC/tfmBen, DMC/tfTol and (b) 2 M-DMC/Ben, DMC/fBen, DMC/1,3-dfBen with a capacity of 0.5 mAh cm⁻² measured at 0.5 mA cm⁻².

FIG. 16 shows the cycling performance of Li—Cu asymmetric cells having different electrolytes at a current density of 1 mA cm⁻² at (a) 1 or (b) 3 mAh cm⁻².

FIG. 17 shows the cycling performance of Li—Li symmetric cells having different electrolytes at a current density of 1 mA cm⁻² at 1 mAh cm-2.

FIG. 18 shows the SEM images of plated lithium in the presence of (c) 5.5 M-DMC, (d) 2 M-DMC/BTFE, (e) 2 M-DMC/1,2-dfBen and (f) triple-1,2-dfBen.

FIG. 19 shows the SEM images of plated lithium in the presence of (a) 2 M-DMC/BTFE, (b) 2 M-DMC/1,2-dfBen and (c) triple-DMC/1,2-dfBen after 30 cycles.

FIG. 20 shows the XPS spectra of SEI layers in the C is branches in the presence of different electrolytes.

FIG. 21 shows the XPS spectra of SEI layers in the presence of (a) 5.5 M-DMC, (b) 2 M-DMC/BTFE, (c) 2 M-DMC/1,2-dfBen and (d) triple-DMC/1,2-dfBen.

FIG. 22 shows the spectra of SEI layers in the F is branches in the presence of different electrolytes.

FIG. 23 shows LSV profiles at a scan rate of 1 mV s⁻¹ in the presence of 2 M-DMC, 2 M-DMC/1,2-dfBen and triple-DMC/1,2-dfBen.

FIG. 24 shows the cyclic voltammetry profiles of NCM523 cathodes at a scan rate of 1 mV s⁻¹ in the presence of (a) LiPF₆-EC/DEC, (b) DMC/BTFE, (c) DMC/1,2-dfBen and (d) triple-DMC/1,2-dfBen.

FIG. 25 shows LSV profiles at a scan rate of 1 mV s⁻¹ in the presence of 5.5 M-DMC, 2 M-DMC/BTFE, 2 M-DMC/1,2-dfBen and triple-DMC/1,2-dfBen.

FIG. 26 shows the SEM images of aluminum current collectors using (a) 1 M LiPF₆-EC/DEC, (b) 2 M-DMC/BTFE, (c) 2 M-DMC/1,2-dfBen and (d) triple-DMC/1,2-dfBen.

FIG. 27 shows the XPS spectra of NCM523 cathodes in (a) C is and (b) F is branches depending on electrolytes.

FIG. 28 shows the cycling performance of NCM523-Li cells depending on electrolytes.

FIG. 29 shows the coulombic efficiency of NCM523-Li cells during cycling.

FIG. 30 shows the cycling performance of NCM523-Li cells using 2 M-DMC/BTFE and 2 M-DMC/1,2-dfBen.

### BEST MODE FOR CARRYING OUT THE INVENTION

The present disclosure can be modified variously and may have various exemplary embodiments. Hereinafter, specific exemplary embodiments will be illustrated in the drawings and described in detail. However, it is not intended to limit the present disclosure to the specific exemplary embodiments and it should be understood that the present disclosure includes all modifications, equivalents and substitutes included in the idea and technical scope of the present disclosure. When describing the present disclosure, a detailed description of the related known technology may be omitted if it is judged that it may obscure the gist of the present disclosure.

Although a lithium metal anode is a good material having higher theoretical capacity, lower electrochemical potential, etc. as compared to the existing graphite anode, there are problems such as nonuniform electrodeposition elution of lithium, depletion of electrolytes and lithium, short circuit due to dendrite formation, etc.

In order to solve these problems, the present disclosure provides an electrolyte for a lithium metal battery, which contains a lithium salt, a solvent and a diluent including 1,2-difluorobenzene (hereinafter, “1,2-dfBen”).

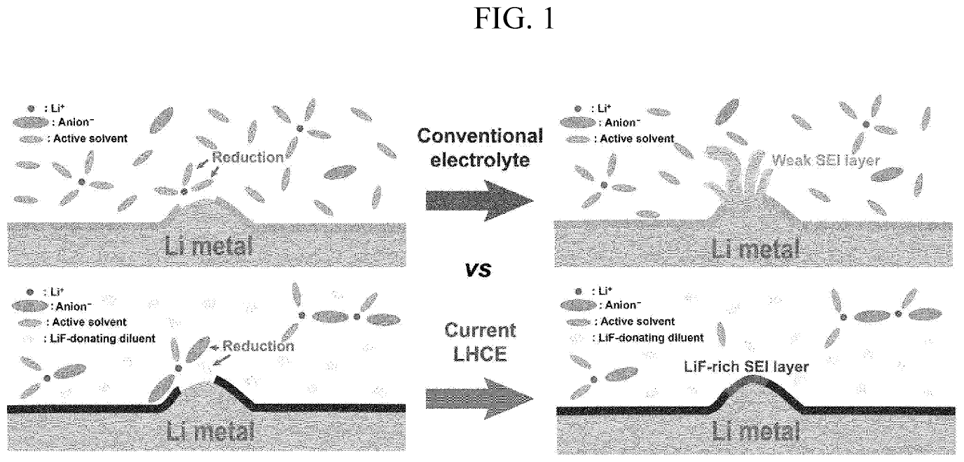

FIG. 1 shows the formation of SEIs in the present disclosure and the prior art.

Referring to FIG. 1, 1,2-dfBen is one of fluorinated aromatic compounds. Since it has a very low LUMO (lowest unoccupied molecular orbital) energy level, it is reduced easily and provides anions to the surface of the lithium metal anode. The anions form a stable solid-electrolyte interphase (hereinafter, “SEI”) in which lithium fluoride (hereinafter, “LiF”) is distributed predominantly and uniformly on the surface of lithium metal through chemical reaction with lithium ions and, through this, dendrite formation can be prevented.

In addition, since the 1,2-dfBen has low binding ability to lithium ions, it can exhibit high-concentration electrolyte effect when used as a diluent because lithium ions, anions and the solvent are associated to form a local area of high concentration of lithium ions. This promotes the formation of LiF on the surface of lithium metal by accelerating the degradation of anions contained in lithium salts and, therefore, can prevent dendrite formation more effectively.

The lithium salt may include one or more selected from a group consisting of lithium bis(fluorosulfonyl)imide (hereinafter, “LiFSI”), lithium bis(trifluoromethanesulfonyl)imide (hereinafter, “LiTFSI”) and lithium hexafluorophosphate (hereinafter, “LiPF6”). Specifically, when the lithium salt contains LiFSI, LiTFSI and LiPF6, the performance of the lithium metal battery may be maximized. In the present specification, a lithium salt containing LiFSI, LiTFSI and LiPF6 is defined as a triple salt. In an exemplary embodiment of the present disclosure, the performance of the battery was maximized when 1.3 M LiFSI, 0.7 M LiTFSI, 0.02 M LiPF6 and DMC/1,2-dfBen were used as electrolytes.

The concentration of the lithium salt may be 0.5-5.5 M, more specifically 1-3 M. Excellent performance may be achieved within the above range because the local area of high concentration of lithium ions formed when 1,2-dfBen is used because the diluent can exhibit a high-concentration electrolyte effect even with a low-concentration lithium salt.

The solvent may include one or more selected from a group consisting of dimethyl carbonate (DMC), diethyl carbonate (DEC), ethyl methyl carbonate (EMC), ethylene carbonate (EC) and propylene carbonate (PC).

Specifically, the concentration of the diluent may be 30-70 vol %. If the concentration of the diluent is below the above range, dendrite formation may be facilitated due to decreased formation of the SEI. And, if it exceeds the above range, the transport of lithium ions may be interrupted because of increased resistance due to excessive SEI formation and cell performance may decrease due to increased consumption of lithium ions during the SEI formation.

The present disclosure also provides a lithium metal battery including a cathode, a lithium metal anode and the electrolyte for a lithium metal battery described above.

The cathode and the lithium metal anode may be prepared by common methods known in the art.

The cathode may further include a current collector. The current collector is not specially limited as long as it has conductivity without causing chemical change in the lithium metal battery. For example, stainless steel, aluminum, nickel, titanium, calcined carbon or aluminum, or stainless-steel surface-treated with carbon, nickel, titanium, silver, etc. may be used.

The electrolyte may suppress the corrosion of the current collector by forming a stable SEI wherein LiF is uniformed dominantly and stably on the surface of the current collector, like the lithium metal anode.

Hereinafter, the present disclosure is described more specifically through specific exemplary embodiments. However, the technical idea of the present disclosure is not limited thereby and may be embodied variously by those skilled in the art.

### Example

### 1. Electrolytes

### 1. Electrolytes

Lithium bis(trifluoromethanesulfonyl)imide (99.95%), lithium hexafluorophosphate (99.99%), dimethyl carbonate (99%), bis(2,2,2-trifluoroethyl) ether (98%), methoxybenzene (anhydrous, 99.7%), (trifluoromethoxy)benzene (99%), benzene (anhydrous, 99.8%), fluorobenzene (99%), 1,2-difluorobenzene (98%) and 1,3-difluorobenzene (99%) were purchased from Sigma Aldrich.

Lithium bis(fluorosulfonyl)imide (98.0%) was purchased from TCI Chemicals.

1 M lithium hexafluorophosphate in ethylene carbonate/diethyl carbonate (v/v=1/1) was purchased from Panax Etec.

All localized high-concentration electrolytes were prepared in solvent mixtures of dimethyl carbonate/diluent (v/v=3/7).

### 2. Cells and Electrochemical Measurements

For full-cell measurement, cathodes were prepared according to the following procedure. LiNi_{0.5}Co_{0.2}Mn_{0.3}O₂(NCM523), Super P and polyvinylidene difluoride (PVDF) were uniformly dispersed in N-methyl 2-pyrrolidone (NMP) at a weight ratio of 90:5:5. The mixed slurry was cast onto an aluminum foil using the doctor blade technique. The cast electrode was dried under vacuum at 80° C. for 12 hours. The areal mass loading of the active material was 17 mg Cm⁻². The electrochemical performance was characterized by preparing 2032 coin-type cells. The full-cells were composed of a Li metal anode with thickness of 40 μm (Honjo Metal, Japan), a polypropylene separator with a thickness of 25 m (Celgard 2400) and an NCM523 cathode together with different electrolytes.

40 μL of the electrolyte was injected into each coin cell and the diameter of the Li metal and the cathode was 13 mm and 12 mm, respectively. Each full-cell was housed in an aluminum case to prevent the corrosion of stainless steel. The asymmetric cell consisted of a Cu foil electrode and a Li metal counter electrode. The full-cell was assembled in an argon-filled glove box and cyclic voltammetry (CV) measurement was performed at a scan rate of 1 mV s⁻¹. All electrochemical measurements were performed at 25° C. using a battery cycler (WBCS3000, Wonatech, South Korea).

### 3. Characterization

For all the characterization after the electrochemical measurements, the cell was disassembled in an argon-filled glove box and the cycled Li metal was washed with a DMC solvent and dried under vacuum for 3 hours in a chamber connected to a glove box.

The chemical composition and binding characteristics of the SEI layer were analyzed by XPS (Sigma Probe, Thermo VG Scientific, England) with a Mg Kα line as the X-ray source. The Raman spectra of various electrolytes were recorded using a Raman spectrometer (DXR2xi, Thermo Fisher, USA). The morphology of the Li metal electrode was characterized by field-emission SEM (JSM-7800F Prime, JEOL, Japan) at the National Center for Inter-University Research Facilities (NCIRF) at Seoul National University. For all characterizations, moisture and air contamination were avoided by using an airtight sample box during sample transfer.

### 4. DFT Calculation

Geometry optimization and molecular orbit energy calculation of selected solvents were performed without symmetry restriction using the B3LYP hybrid density functional implemented in the Gaussian 09 software package according to the density Functional Theory (DFT) calculation method. The 6-31+G(d,p) basis sets were used for all the atoms. Frequency calculation of the same basis sets was conducted to determine the nature of a stationary point as the true local minimum. Geometry calculation was performed in gas phase to compare the trends of the selected solvents.

### Test Example

### 1. Measurement of LUMO Energy Levels

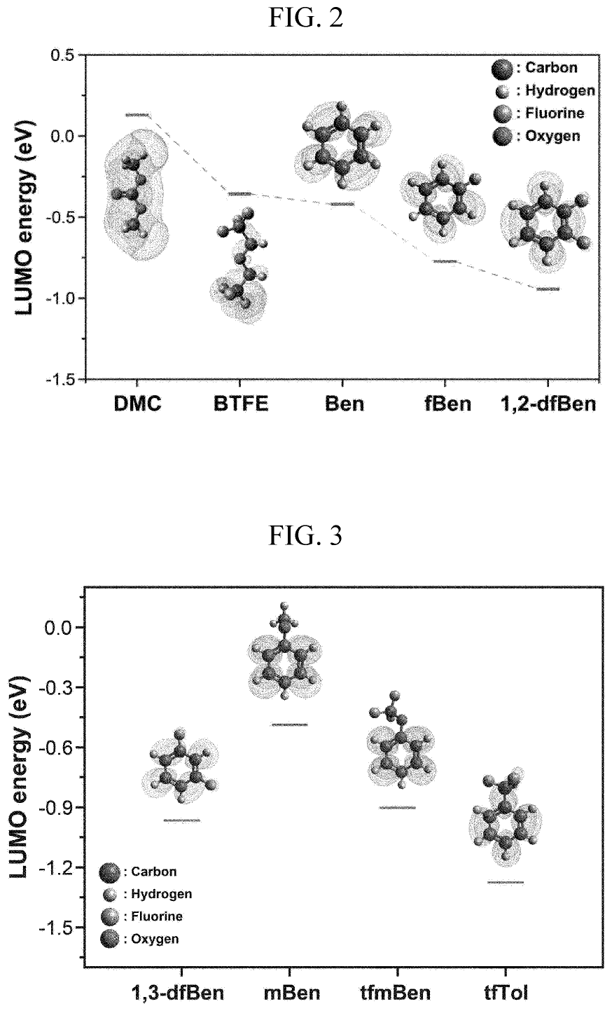

FIGS. 2 and 3 show LUMO energy levels, and Table 1 shows LUMO levels, binding energies and cycling.

TABLE 1

| | | Binding | Chemical | |
|---|---|---|---|---|
| | LUMO level | energy | reactivity | Cyclability |
| Solvent | (eV) | (eV) | with Li metal | (cycle) |
| DMC | 0.129 | −1.57 | X | 7 |
| BTFE | −0.357 | −1.41 | X | 159 |
| Ben | −0.421 | −1.23 | X | 189 |
| fBen | −0.774 | −0.98 | X | 196 |
| 1,2-dfBen | −0.943 | −0.76 | ◯ | 288 |
| 1,3-dfBen | −0.965 | −0.74 | X | 232 |
| mBen | −0.487 | −1.54 | X | 123 |
| tfmBen | −0.902 | −1.03 | X | 176 |
| tfTol | −1.276 | −0.91 | X | 218 |

The LUMO level is generally accepted as a descriptor to determine the reduction priority upon electrochemical bias such that the lower the LUMO level is, the earlier reduction occurs. Referring to FIGS. 2 and 3 and Table 1, DMC showed the highest LUMO level of 0.129 eV, followed by BTFE at −0.357 eV. In the case of the benzene derivatives, the LUMO level typically decreases as hydrogen is increasingly substituted by fluorine because the strong electronegativity of the fluorine atom withdraws electrons from the benzene ring. This trend was observed indeed for mBen and tfmBen. The LUMO level of 1,2-dfBen was −0.943 eV, which is significantly lower than that of BTFE, suggesting the possibility of undergoing facile reduction on the surface of lithium metal.

2. Reactivity with Lithium Metal

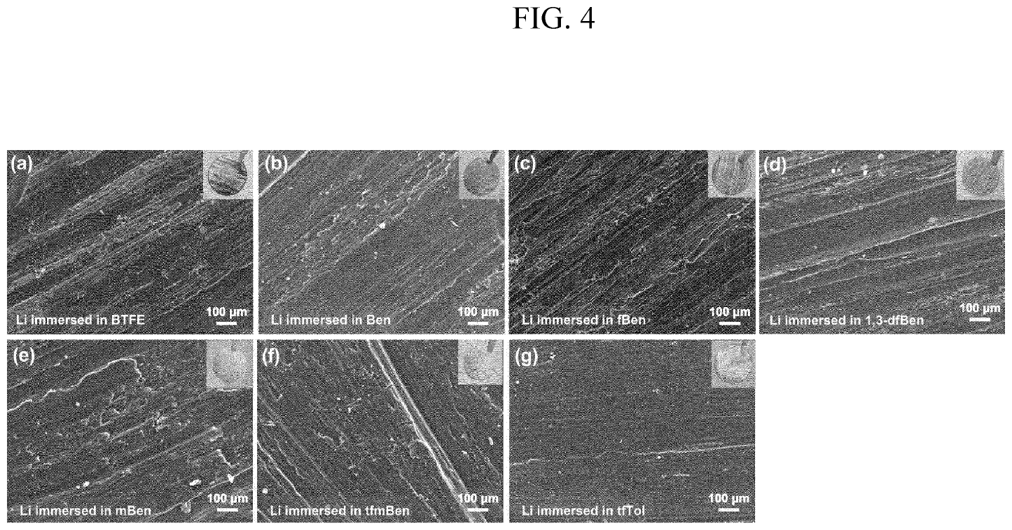

FIG. 4 shows the SEM images of Li metal after immersion in (a) BTFE, (b) Ben, (c) fBen, (d) 1,3-dfBen, (e) mBen, (f) tfmBen and (g) tfTol for 1 day.

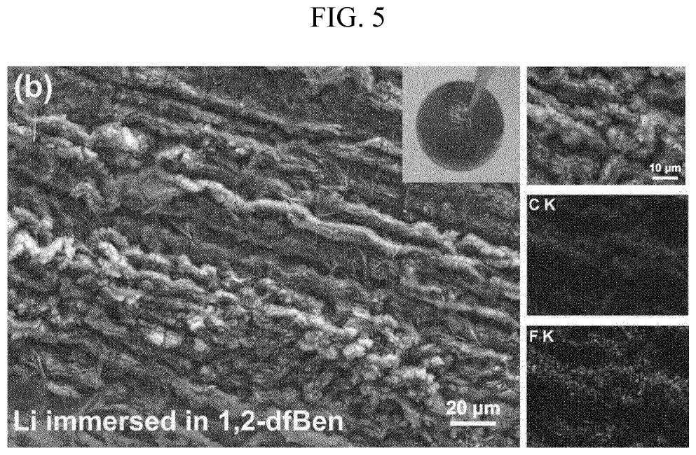

FIG. 5 shows the SEM image of Li metal after immersion in 1,2-dfBen for 1 day and its EDS mapping images with respect to carbon and fluorine. The insert is a digital photograph of the same Li metal foil.

Referring to FIGS. 4 and 5, whereas the surface of lithium metal remained smooth for (a)-(g), the surface of the lithium metal exposed to 1,2-dfBen exhibited a highly uneven morphology and was composed of carbon and fluorine.

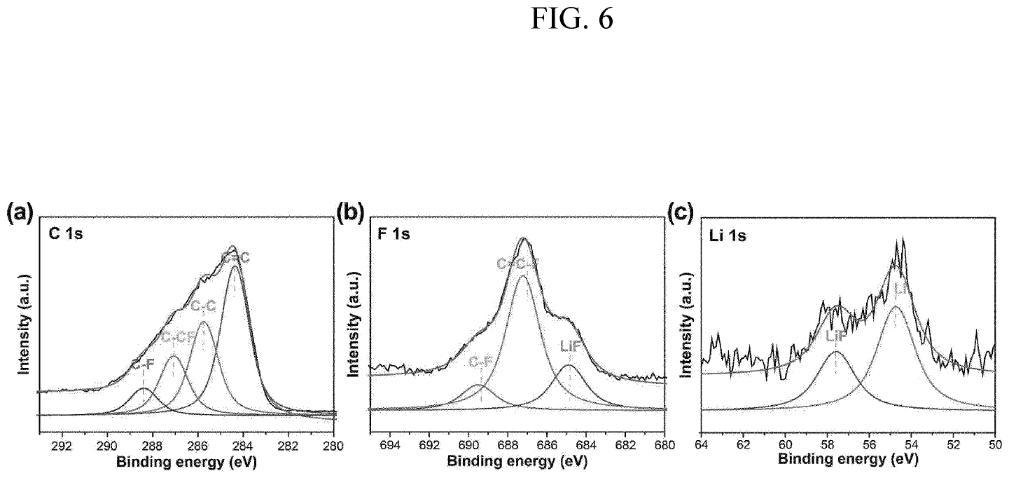

FIG. 6 shows the XPS spectra of Li metal after immersion in 1,2-dfBen for 1 day.

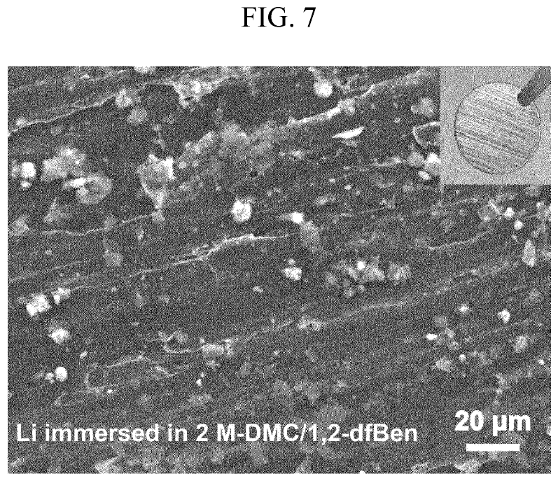

FIG. 7 shows the SEM image of Li metal after immersion in 2 M-DMC/1,2-dfBen for 1 day.

Referring to FIGS. 6 and 7, as a result of the XPS (X-ray photoelectron spectroscopy) analysis, the C is branch displayed peaks at 284.2, 285.8, 287.1 and 288.4 eV, which can be assigned to C=C, C—C, C—C, C—CF and C—F bonds, respectively (a). For the F is branch, peaks were detected at 684.8, 687.2 and 689.8 eV, corresponding to LiF, C═C—F and C—F bonds, respectively (b). The relatively weak intensity of the C—F bond and the appearance of LiF suggest that 1,2-dfBen reacted with Li metal to produce LiF and graphitic carbon as products. The formation of graphitic carbon is attributed to the decomposition of the benzene ring of 1,2-dfBen and the formation of LiF was additionally verified by the peak at 57.6 eV in the Li is branch (c). In addition, when the Li metal foil was immersed in an electrolyte containing 1,2-dfBen for one day, the color and level of gloss did not change significantly, implying that once the Li foil is passivated by the SEI layer, the Li foil is protected from further reaction with 1.2-dfBen.

3. Comparison of Free Energy of 1,2-dfBen and 1,3-dfBen

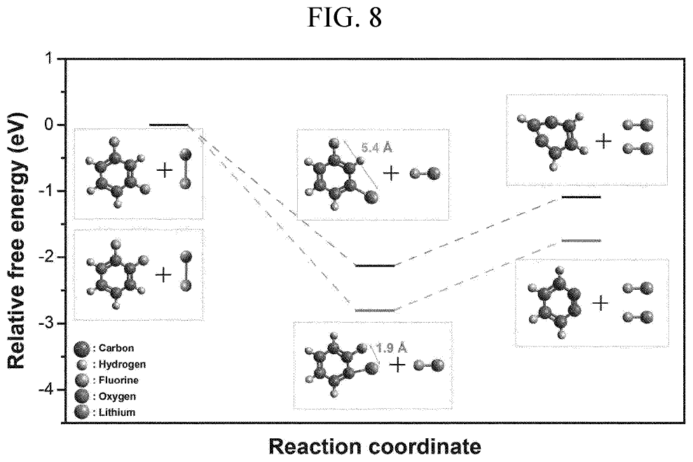

FIG. 8 shows the free energy of 1,2-dfBen and 1,3-dfBen during reaction.

The free energy of the two substances was calculated by density functional theory (DFT) calculation.

Referring to FIG. 8, the free energy of 1,2-dfBen was conspicuously lower relative to the free energy of 1,3-dfBen in both steps involving sequential LiF formation. It is because the smaller Li—F distance of 1,2-dfBen in the organolithium complex compared to that of 1,3-dfBen (1.9 vs. 5.4 Å) imposes a lower activation energy barrier on subsequent LiF formation. Thus, although 1,2-dfBen is isomeric to 1,3-dfBen, the adjacent fluorine positions of 1,2-dfBen further promote the LiF formation as the reacting Li and F at the intermediate state are bonded to the benzene ring at the same time. This potential difference of fluorine explains the more facile formation of LiF in the SEI layer of 1,2-dfBen.

4. Measurement of Binding Energy with Lithium Ions

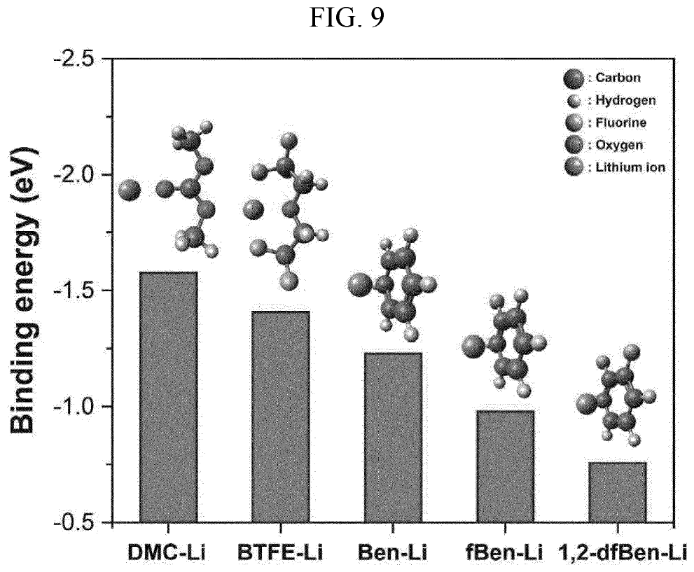

FIGS. 9-11 show binding energy with lithium ions.

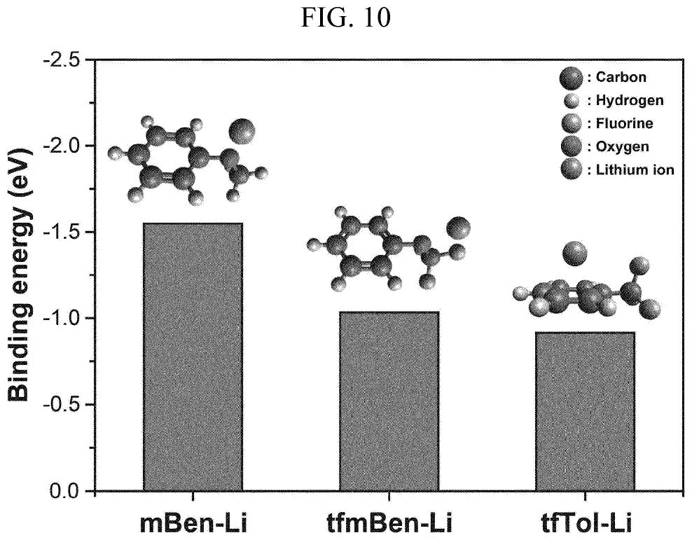

Referring to FIGS. 9 and 10, the binding energy of DMC was −1.57 eV, whereas the binding energy of BTFE, a known diluent used in localized high-concentration electrolytes (hereinafter, “LHCEs”), was −1.41 eV, suggesting that DMC likely binds excessively with a lithium ion in DMC/BTFE mixtures. The binding energy of Ben was −1.23 eV owing to the absence of functional groups with an effective negative charge.

Noteworthy is that the binding energy of mBen having an ether functional group was comparatively high at −1.54 eV. In the case of the benzene derivatives, as the number of fluorine substituents increases, the binding energy decreases because the fluorine withdraws electrons from the benzene ring. Based on the combined effect of the benzene ring and fluorine substitution, 1,2-dfBen had the lowest binding energy of −0.76 eV, thereby confirming its superior diluting power in LHCEs.

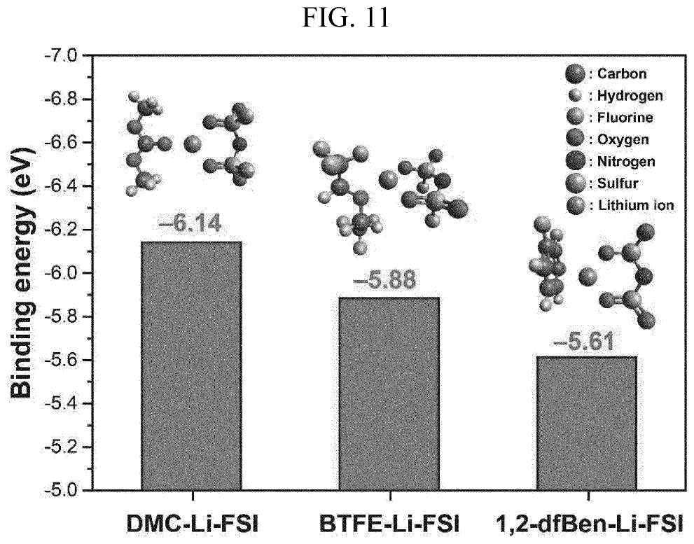

Referring to FIG. 11, consistent results were obtained when the FSI-anion was taken into account in the evaluation of the binding energy.

### 5. Analysis of Raman Spectra of Electrolytes

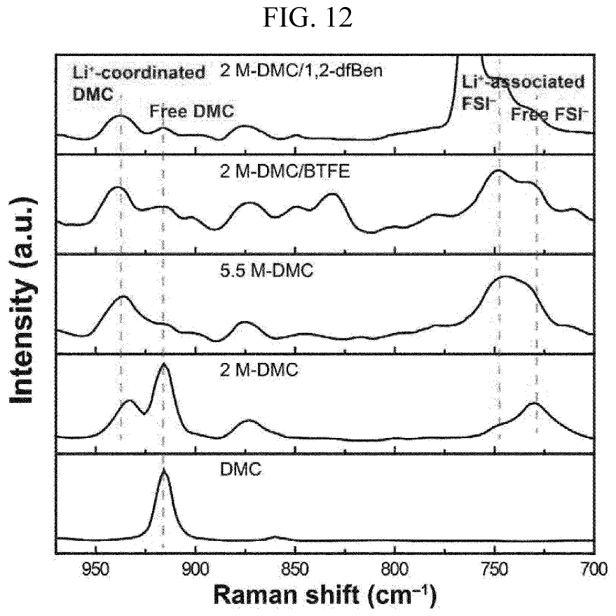

FIG. 12 shows Raman spectra depending on concentration.

For analysis of the Raman spectra, localized high-concentration electrolytes (LHCEs) in solvent mixtures of DMC/diluent (v/v=3/7) were used.

Referring to FIG. 12, upon coordination with a lithium ion, the corresponding peaks of DMC or FSI⁻ shifted to longer wavelengths. When the concentration of the LiFSI salt was increased from 0 M to 5.5 M, the peak of free DMC at 920 cm⁻¹ was weakened gradually at the expense of the growth of the peak of Li⁺-coordinated DMC at 940 cm⁻¹. A similar trend was observed for FSI⁻. The increase in the salt concentration decreased the peak intensity of free FSI⁻ at 725 cm⁻¹ and increased the peak intensity of Li⁺-associated FSI⁻ at 750 cm⁻¹.

Importantly, when DMC was diluted by BTFE or 1,2-dfBen, the peak at 940 cm⁻¹ corresponding to Li⁺-coordinated DMC was preserved to a greater extent, indicating the more persistent coordination environment of DMC and FSI⁻ even after the addition of BTFE and 1,2-DfBen.

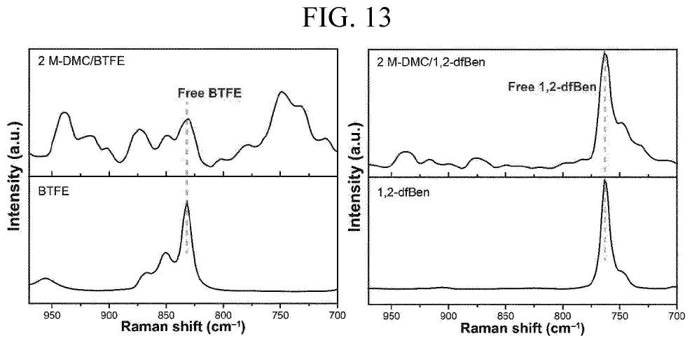

FIG. 13 shows the Raman spectra BTFE, 2 M-DMC/BTFE, 1,2-dfBen and 2 M-DMC/1,2-dfBen.

Referring to FIG. 13, the diluent character of BTFE and 1,2-dfBen was also revealed by the peaks of free BTFE and 1,2-dfBen that were largely preserved in the electrolytes. In addition, 2 M LiFSI-DMC/1,2-dfBen (hereinafter, “2 M DMC/1,2-dfBen”) more effectively maintained the relative peak ratio between the coordinated DMC and free DMC compared to that of 2 M-DMC/BTFE. This observation is in good agreement with the result of binding energy calculations in that 1,2-dfBen is less interactive.

### 6. Evaluation of Electrochemical Performance of Cells

Coulombic efficiency (hereinafter, “CE”) was defined as the charging (Li stripping) capacity over the discharging (Li plating) capacity.

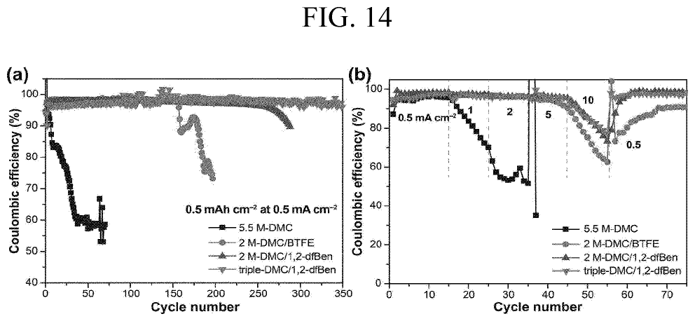

FIG. 14 shows the cycling performance of Li—Cu asymmetric cells using different electrolytes with a capacity of 0.5 mAh cm⁻² at current densities of (a) 0.5 mA cm⁻² and (b) 0.5, 1, 2, 5 and 10 mA cm-2.

Referring to FIG. 14, when cycled at a fixed capacity of 0.5 mAh cm⁻² at 0.5 mA cm⁻² for each charge and discharge, the coulombic efficiency of the cell with 5.5 M-DMC decayed rapidly after 10 cycles, implying the moderate high-concentration effect of the electrolyte.

Although 5.5 M-DMC was previously reported to deliver high-concentration effect with surfactant-coated separators, the cells with bare separators used in this study exhibited limited cyclability because of poor electrolyte wetting, unveiling the negative effect of the high-concentration electrolyte effect when adopted for cells with common polyethylene or polypropylene separators.

In the case of 2 M-DMC/BTFE, the cycling period with coulombic efficiency (>90%) was extended to 159 cycles owing to the improved wettability.

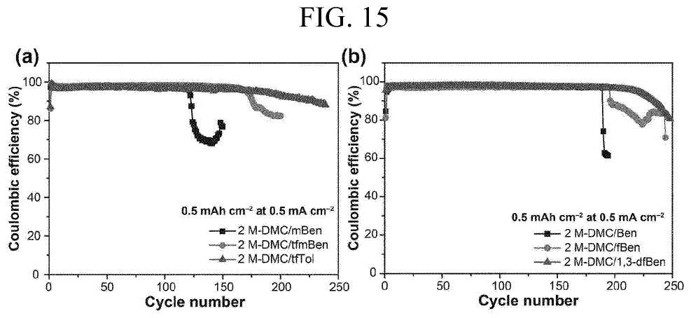

FIG. 15 shows the cycling performance of Li—Cu asymmetric cells with different electrolytes (a) 2 M-DMC/mBen, DMC/tfmBen, DMC/tfTol and (b) 2 M-DMC/Ben, DMC/fBen, DMC/1,3-dfBen with a capacity of 0.5 mAh cm⁻² measured at 0.5 mA cm⁻².

Referring to FIG. 15, in the case of the benzene derivatives with the same salt condition, the cyclability of the cells with LHCEs diluted by Ben and fBen was improved, sustaining high CE (>90%) for 189 and 196 cycles, respectively.

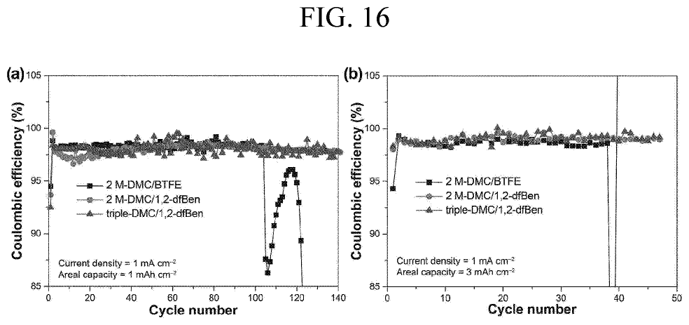

FIG. 16 shows the cycling performance of Li—Cu asymmetric cells having different electrolytes at a current density of 1 mA cm⁻² at (a) 1 or (b) 3 mAh cm⁻².

To further enhance the cell performance, triple salts such as 1.3 M LiFSI+0.7 M LiTFSI+0.02 M LiPF₆ in DMC/1,2-dfBen (hereinafter, “triple-DMC/1,2-dfBen”) were prepared as electrolytes.

Referring to FIG. 16, the average CE of 2 M-DMC/1,2-dfBen and triple-DMC/1,2-dfBen for 200 cycles was 97.7% and 97.5%, respectively. When the areal capacity was increased to 1 and 3 mAh cm⁻², the average coulombic efficiency of 2 M-DMC/1,2-dfBen and triple-DMC/1,2-dfBen was increased to 98.3% and 98.2% for 1 mAh cm⁻²(for 100 cycles) and to 99.0% and 99.1% for 3 mAh cm⁻²(for 40 cycles), respectively. The increased values at 3 mAh cm⁻² are attributed to the decreased portion of the SEI layer that sacrificed the coulombic efficiency.

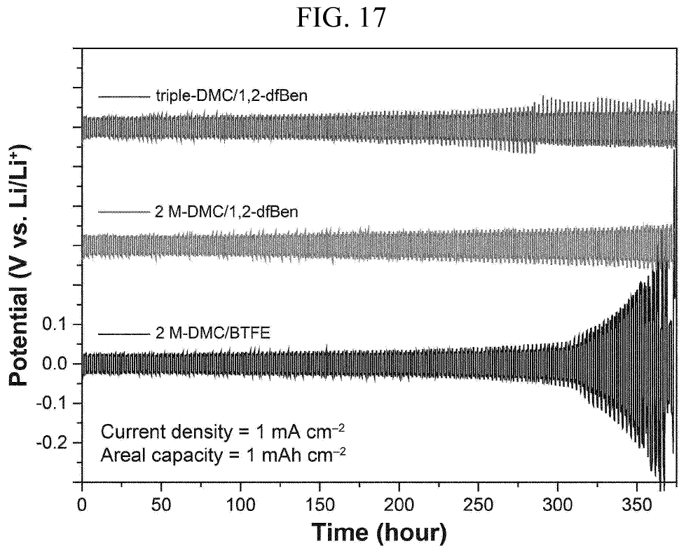

FIG. 17 shows the cycling performance of Li—Li symmetric cells having different electrolytes at a current density of 1 mA cm⁻² at 1 mAh cm⁻².

Referring to FIG. 17, the 1,2-dfBen diluent showed the strongest cyclability under the symmetric cell setting.

### 7. Morphological Analysis of Plated Lithium

Li with a capacity of 1 mAh cm⁻² was electrodeposited on a Cu current collector at a current density of 0.5 mA cm⁻².

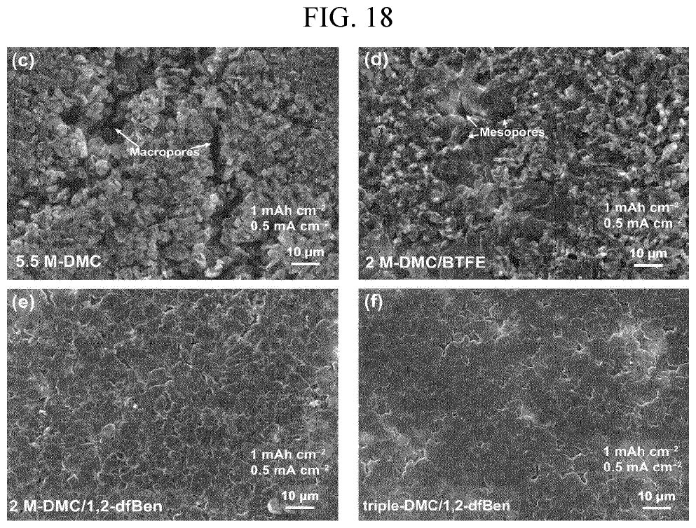

FIG. 18 shows the SEM images of plated lithium in the presence of (c) 5.5 M-DMC, (d) 2 M-DMC/BTFE, (e) 2 M-DMC/1,2-dfBen and (f) triple-1,2-dfBen.

Referring to FIG. 18, the lithium plated in 5.5 M-DMC exhibited granular morphologies with particle sizes of 2-5 μm and abundant macrophores between lithium bundles. The lithium plated in 2 M-DMC/BTFE showed larger granule sizes of 5-15 μm but fewer macrophores. In contrast, the lithium plated in 2 M-DMC/1,2-dfBen displayed granules that were flatter and more compact with fewer macro- and mesopores.

This morphological trend was more prominent for the electrolyte triple-DMC/1,2-dfBen such that the Li deposits had even greater flatness and compactness, owing to the synergic effect of the triple salts and the fluorine-donating nature of 1,2-dfBen.

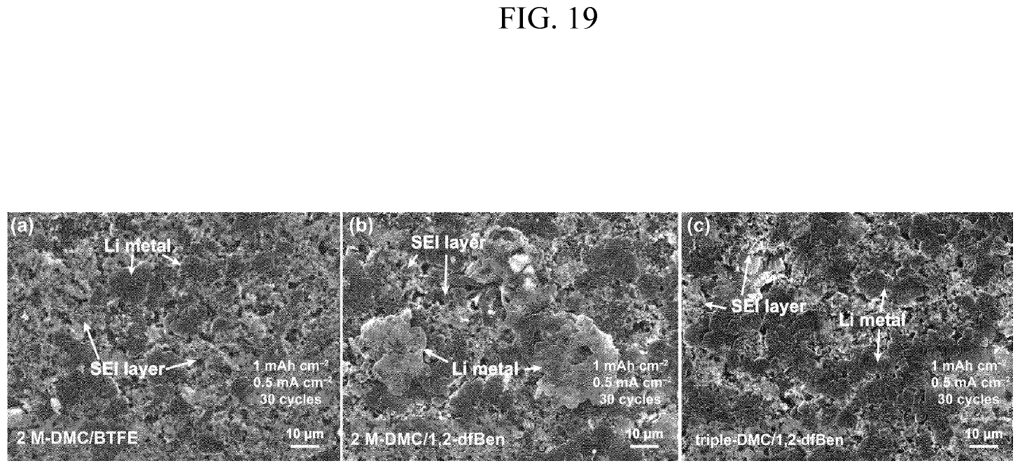

FIG. 19 shows the SEM images of plated lithium in the presence of (a) 2 M-DMC/BTFE, (b) 2 M-DMC/1,2-dfBen and (c) triple-DMC/1,2-dfBen after 30 cycles.

Referring to FIG. 19, after 30 cycles, the pore-rich SEI layer was observed more prominently in 2 M-DMC/BTFE due to significantly increased dendrite formation. This phenomenon was less prominent in 2 M-DMC/1,2-dfBen and triple-DMC/1,2-dfBen.

### 8. Analysis of Composition of SEI Layer

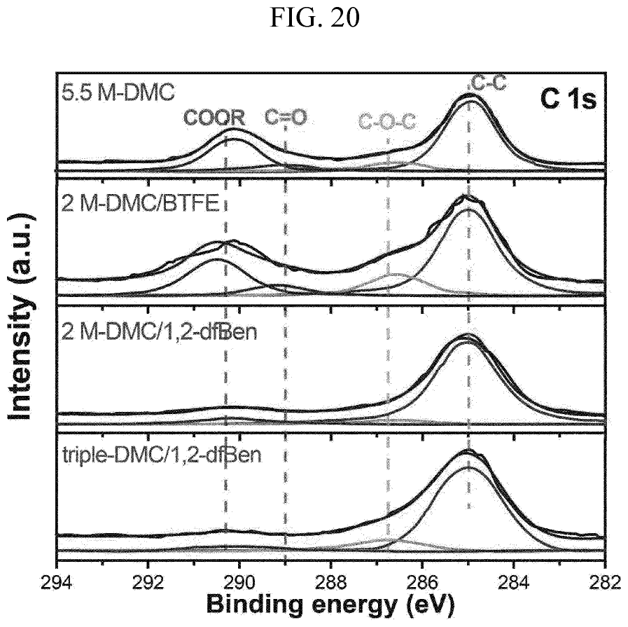

FIG. 20 shows the XPS spectra of SEI layers in the C is branches in the presence of different electrolytes.

Referring to FIG. 20, in the C is branches, the peaks observed at 290.3, 289.0, 286.8 and 285.0 eV can be assigned to COOR, C═O, C—O—C and C—C bonds, respectively, and the peaks related to the bonds are attributed to the decomposition of DMC. The more prominent COOR, C═O and C—O—C peaks of 5.5 M-DMC and 2 M-DMC/BTFE indicate more significant decomposition of DMC in these electrolytes.

In contrast, these peaks were suppressed pronouncedly with 2 M-DMC/1,2-dfBen and triple-DMC/1,2-dfBen, reflecting the weakened decomposition of DMC.

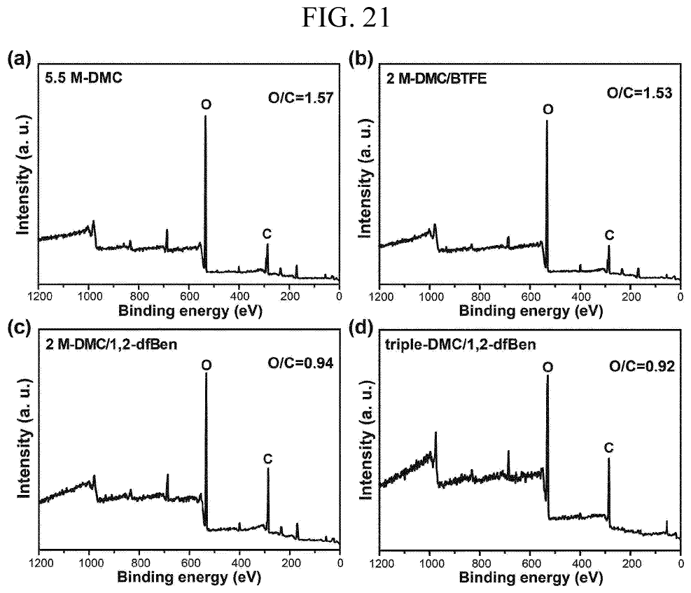

FIG. 21 shows the XPS spectra of SEI layers in the presence of (a) 5.5 M-DMC, (b) 2 M-DMC/BTFE, (c) 2 M-DMC/1,2-dfBen and (d) triple-DMC/1,2-dfBen.

Referring to FIG. 21, the former two electrolytes showed higher O-to-C atomic ratios than the latter two electrolytes.

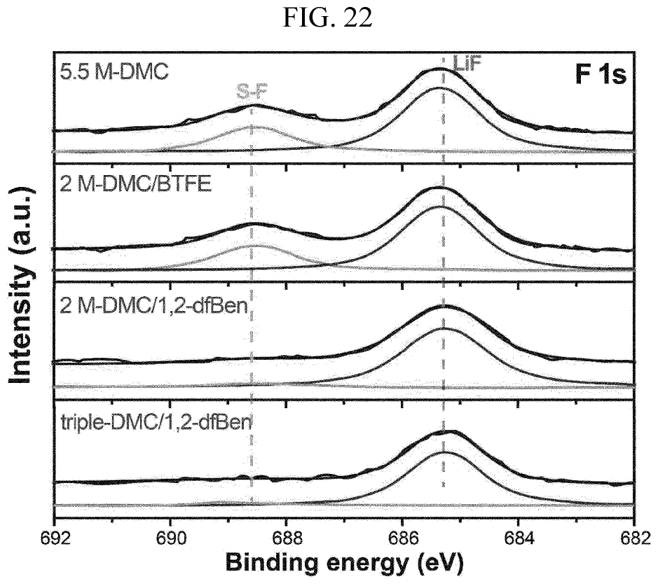

FIG. 22 shows the spectra of SEI layers in the F is branches in the presence of different electrolytes.

Referring to FIG. 22, the 2 M-DMC/1,2-dfBen and triple-DMC/1,2-dfBen electrolytes exhibited higher LiF-to-S—F peak ratios (assigned to the peaks at 685.3 and 688.8 eV, respectively) compared to those of 5.5 M-DMC and 2 M-DMC/BTFE.

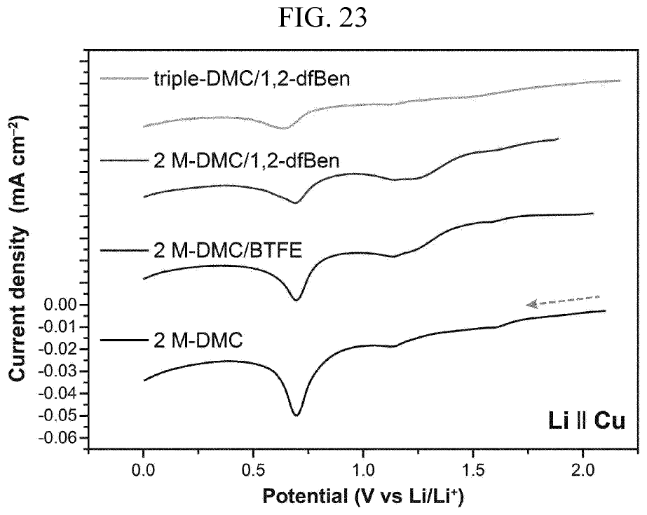

FIG. 23 shows LSV profiles at a scan rate of 1 mV s⁻¹ in the presence of 2 M-DMC, 2 M-DMC/1,2-dfBen and triple-DMC/1,2-dfBen.

Referring to FIG. 23, considering the similar linear scanning voltammetry (LSV) profiles of the different electrolytes, the above observation can be interpreted as indicating that the FSI-anions coordinated with lithium ions as well as 1,2-dfBen itself were both preferentially decomposed in contact with metallic lithium during lithium plating, leading to the formation of the LiF-rich SEI layer.

### 9. Evaluation of Oxidation-Reduction Reaction of Cathode

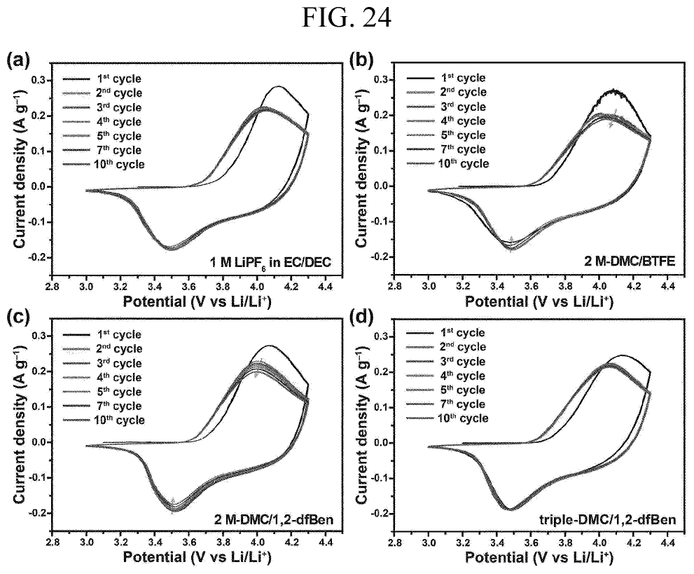

FIG. 24 shows the cyclic voltammetry profiles of NCM523 cathodes at a scan rate of 1 mV s⁻¹ in the presence of (a) LiPF₆-EC/DEC, (b) DMC/BTFE, (c) DMC/1,2-dfBen and (d) triple-DMC/1,2-dfBen.

Referring to FIG. 24, in the case of 2 M-DMC/BTFE and 2 M-DMC/1,2-dfBen, the reduction and oxidation peaks decreased gradually as a result of the corrosion of the aluminum current collector caused by the LiFSI salt.

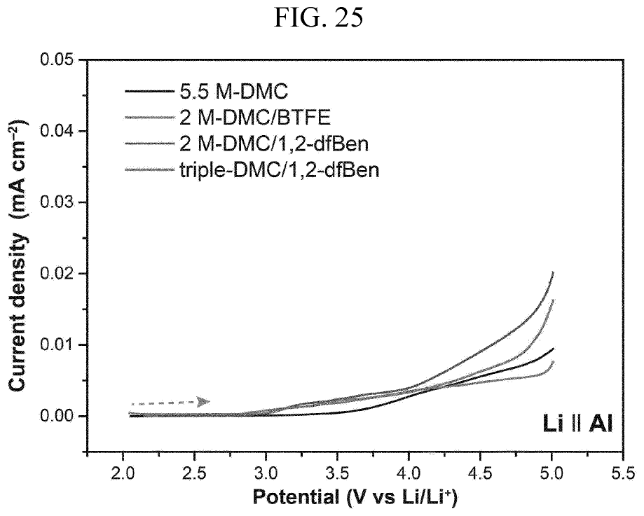

FIG. 25 shows LSV profiles at a scan rate of 1 mV s⁻¹ in the presence of 5.5 M-DMC, 2 M-DMC/BTFE, 2 M-DMC/1,2-dfBen and triple-DMC/1,2-dfBen.

The cell consisted of aluminum as a working electrode and lithium as a counter/reference electrode. Referring to FIG. 25, in contrast to FIG. 24, the cell with triple-DMC/1,2-dfBen exhibited stable CV cycles, similar to that with 1 M LiPF₆-EC/DEC, indicating that the triple salt suppressed the corrosion of aluminum effectively.

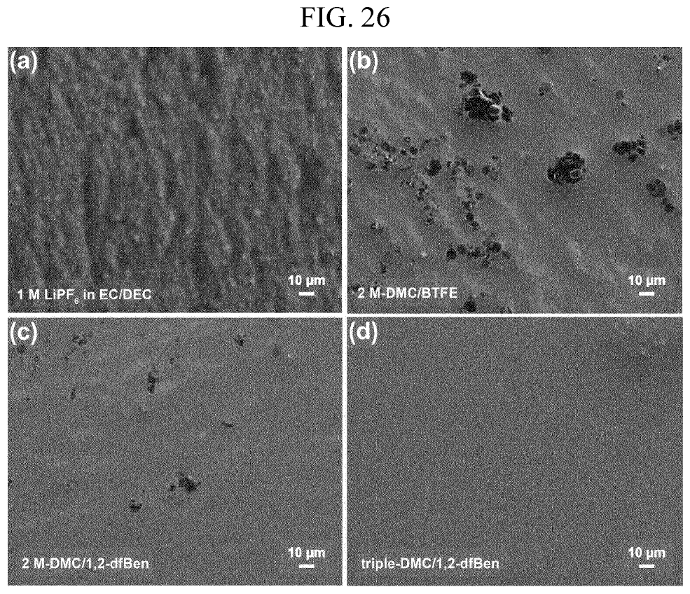

FIG. 26 shows the SEM images of aluminum current collectors using (a) 1 M LiPF₆-EC/DEC, (b) 2 M-DMC/BTFE, (c) 2 M-DMC/1,2-dfBen and (d) triple-DMC/1,2-dfBen.

Referring to FIG. 26, as a result of observing the surface of the aluminum current collector after 10 CV cycles, whereas the corrosion of aluminum occurred for (a) 1 M LiPF₆-EC/DEC and (b) 2 M-DMC/BTFE, clean surface was observed for (c) 2 M-DMC/1,2-dfBen and (d) triple-DMC/1,2-dfBen due to the corrosion of aluminum, indicating that the electrolytes containing 1,2-dfBen are effective for preventing the corrosion of the aluminum current collector.

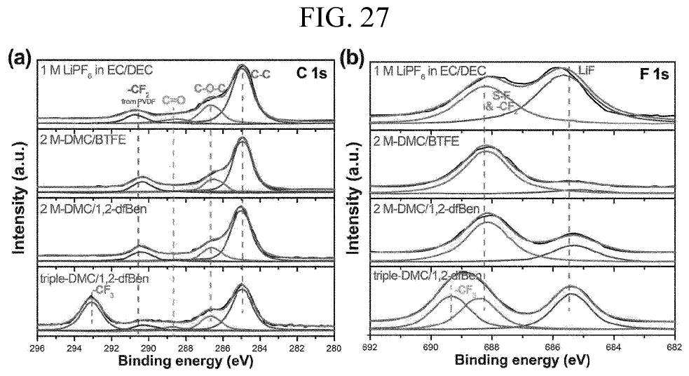

FIG. 27 shows the XPS spectra of NCM523 cathodes in (a) C is and (b) F is branches depending on electrolytes.

Referring to FIG. 27, it can be seen that triple-DMC/1,2-dfBen contributed to the formation of the SEI layer containing —CF₃ and LiF.

### 10. Cycling Test

Cycling test was carried out by galvanostatically cycling the cells at 0.1 C (1 C=3 mA cm⁻²) for the first two cycles and then at 0.5 C for subsequent cycles. The mass loading of the active material in the cathode was 17 mg cm⁻² and the thickness of the lithium foil in the anode was 40 mm.

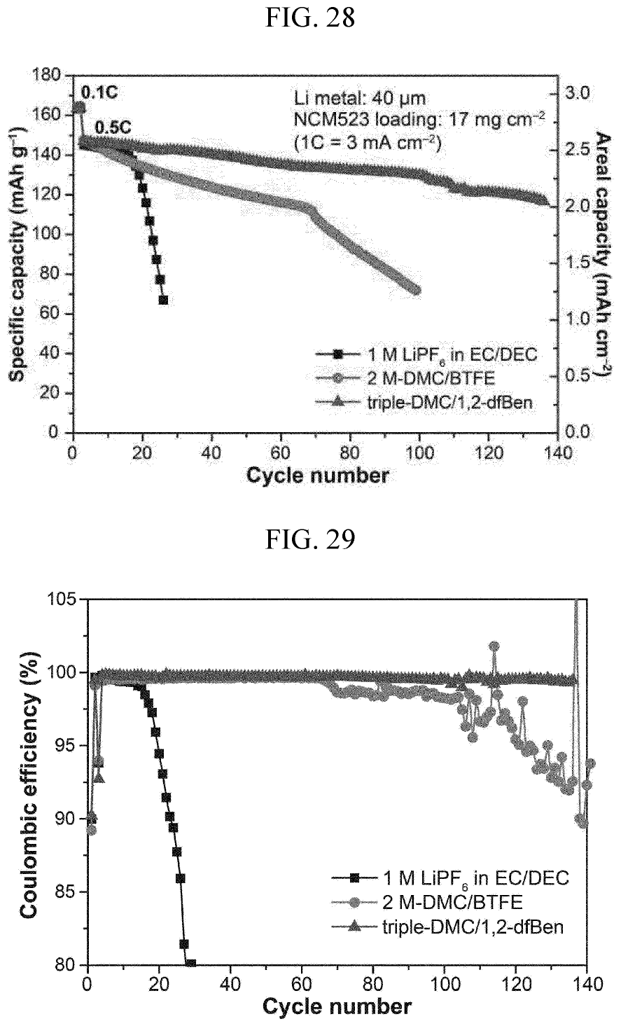

FIG. 28 shows the cycling performance of NCM523-Li cells depending on electrolytes.

Referring to FIG. 28, the capacity of the cell with 1 M LiPF₆-EC/DEC decreased abruptly after only 17 cycles, which is attributed to the depletion of lithium metal. Although the cell with 2 M-DMC/BTFE maintained 111 mAh g⁻¹ for 70 cycles with a capacity fade rate of 0.42% per cycle, it decayed more rapidly for the next 30 cycles.

FIG. 29 shows the coulombic efficiency of NCM523-Li cells during cycling.

Referring to FIG. 29, the decrease in capacity corresponded well with the CE result shows in FIG. 28, which showed average values of 99.58% for the first 70 cycles and 98.60% for the next 30 cycles. Through this, it can be inferred that the lithium metal was depleted at around the 70th cycle.

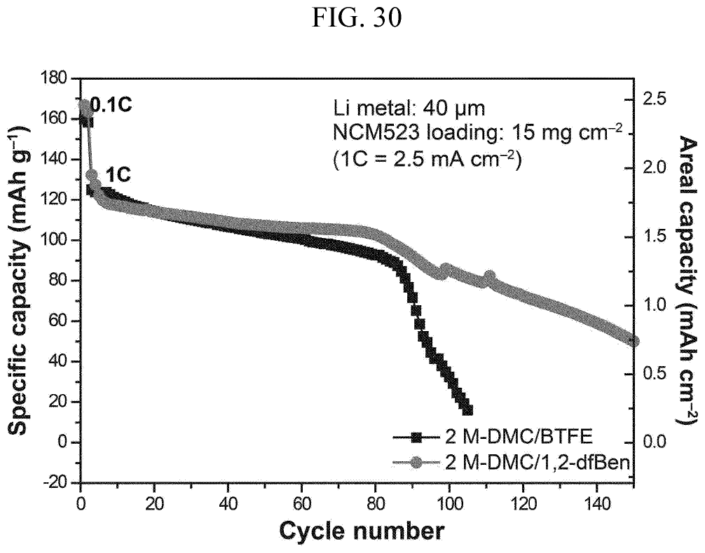

FIG. 30 shows the cycling performance of NCM523-Li cells using 2 M-DMC/BTFE and 2 M-DMC/1,2-dfBen.

Referring to FIG. 30, although 2 M-DMC/1,2-dfBen showed better cycling performance than that of 2 M-DMC/BTFE, the capacity fading of 2 M-DMC/1,2-dfBen was substantial after 80 cycles due to lithium depletion. In contrast, the cell with triple-DMC/1,2-dfBen was vastly superior in terms of maintaining capacity, as it retained 130 mAh g⁻¹ after 100 cycles with a capacity fade rate of 0.14% per cycle, followed by 0.41% per cycle for the next 40 cycles. The average CE was 99.70% for the first 100 cycles and 99.47% for the next 40 cycles.

Table 2 shows the cycling performance of lithium metal batteries using carbonate-based electrolytes.

TABLE 2

| Li (μm) cathode | | | | Cycling | |
|---|---|---|---|---|---|
| (mAh cm⁻²) | Electrolyte | Test condition | | performance | Ref |
| Li (50) 1 NMC622 | 1.0M LiPF₆ in FEC/DMC | 0.5 | mA cm⁻² | 90 cycles, | ^{[2]} |
| (3.3) | | | | 90% | |
| Li (50) 1 NMC811 | 1.0M LiFSI in | 0.5 | mA cm⁻² | 300 cycles, | ^{[3]} |
| (1.5) | DME/TFEO | | | 80% | |
| Li (200) 1 NMC622 | 1.0M LiPF₆ in FEC/EMC | 0.9 | mA cm⁻² | 500 cycles, | ^{[4]} |
| (1.8) | | | | 65% | |
| Li (400) 1 NMC111 | 1.2M LiFSI in | Charge: 1 mA cm⁻² | | 700 cycles, | ^{[5]} |
| (2.0) | DMC/BTFE | discharge: 4 mA cm⁻² | | 80% | |
| Li (10) 1 NMC811 | 1.0M LiPF₆ in | — | | 120 cycles, | ^{[6]} |
| (2.0) | FEC/FEMC/HFE | | | 100% | |
| Li (250) 1 NMC111 | 0.6M LiTFSI/0.4M | 1.1 | mA cm⁻² | 200 cycles, | ^{[7]} |
| (1.1) | LiBOB/0.05 M LiPF₆ in | | | 93% | |
| | EC/PC | | | | |
| Li (200) 1 | 1.0M LiPF₆/0.05M | 3.6 | mA cm⁻² | 300 cycles, | ^{[8]} |
| NMC751510 (4.1) | LiDFOB in FEC/EMC | | | 88% | |
| Li (50) 1 NMC811 | 1.7M LiFSI in DME/TTE | 1.4 | mA cm⁻² | 150 cycles, | ^{[9]} |
| (4.2) | | | | 80% | |
| Li (—) 1 NMC622 | LIFSI/DMC/TTE = | 3 | mA cm⁻² | 200 cycles, | ^{[10]} |
| (1.5) | 1/1.5/1.5 (mol/mol/mol) | | | 80% | |
| Li (13) 1 | 7.0M LiFSI in FEC | 0.5 | mA cm⁻² | 130 cycles, | ^{[11]} |
| LiNi_{0.5}Mn_{1.5}O₄ | | | | 80% | |
| (1.8) | | | | | |
| Li (—) 1 NMC622 | 10.0M LiFSI in EC/DMC | — | | 100 cycles | ^{[12]} |
| (2.5) | | | | 86% | |
| Li (13) 1 NMC622 | 1.0M LiTFA in DME/FEC | 1.1 | mA cm⁻² | 130 cycles, | ^{[13]} |
| (1.1) | | | | 86% | |
| Li (26) 1 | 4.0M LiTFSI/0.5M | 0.9 | mA cm⁻² | 100 cycles | ^{[14]} |
| LiNi_{0.5}Mn_{1.5}O₄ | LiDFOB in FEC/DMC | | | 88% | |
| (1.8) | | | | | |
| Li (40) 1 NMC523 | 1.3M LiFSI/0.7M | 1.5 | mA cm⁻² | 100 cycles, | Present |
| (2.5) | LiTFSI/0.02M LiPF₆ in | | | 90% | disclosure |
| | DMC/1,2-dfBen | | | | |

References are as follows. [2] E. Markevich, G. Salitra, F. Chesneau, M. Schmidt, D. Aurbach, ACS Energy Lett. 2017, 2, 1321-1326. [3] X. Cao, X. Ren, L. Zou, M. H. Engelhard, W. Huang, H. Wang, B. E. Matthews, H. Lee, C. Niu, B. W. Arey, Y. Cui, C. Wang, J. Xiao, J. Liu, W. Xu, J.-G. Zhang, Nat. Energy 2019, 4, 796-805. [4] S.-J. Park, J.-Y. Hwang, C. S. Yoon, H.-G. Jung, Y.-K. Sun, ACS Appl. Mater. Interfaces 2018, 10, 17985-17993. [5] 5. Chen, J. Zheng, D. Mei, K. S. Han, M. H. Engelhard, W. Zhao, W. Xu, J. Liu, J.-G. Zhang, Adv. Mater. 2018, 30, 1706102. [6] X. Fan, L. Chen, O. Borodin, X. Ji, J. Chen, S. Hou, T. Deng, J. Zheng, C. Yang, S.-C. Liou, K. Amine, K. Xu, C. Wang, Nat. Nanotechnol. 2018, 13, 715-722. [7] T. Jin, Y. Wang, Z. Hui, B. Qie, A. Li, D. Paley, B. Xu, X. Wang, A. Chitu, H. Zhai, T. Gong, Y. Yang, ACS Appl. Mater. Interfaces 2019, 11, 17333-17340. [8] J.-Y. Hwang, S.-J. Park, C. S. Yoon, Y.-K. Sun, Energy Environ. Sci. 2019, 12, 2174-2184. [9] X. Ren, L. Zou, X. Cao, M. H. Engelhard, W. Liu, S. D. Burton, H. Lee, C. Niu, B. E. Matthews, Z. Zhu, C. Wang, B. W. Arey, J. Xiao, J. Liu, J.-G. Zhang, W. Xu, Joule 2019, 3, 1662-1676. [10] N. Piao, X. Ji, H. Xu, X. Fan, L. Chen, S. Liu, M. N. Garaga, S. G. Greenbaum, L. Wang, C. Wang, X. He, Adv. Energy Mater. 2020, 10, 1903568. [11] L. Suo, W. Xue, M. Gobet, S. G. Greenbaum, C. Wang, Y. Chen, W. Yang, Y. Li, J. Li, Proc. Natl. Acad. Sci. U.S.A. 2018, 115, 1156. [12] X. Fan, L. Chen, X. Ji, T. Deng, S. Hou, J. Chen, J. Zheng, F. Wang, J. Jiang, K. Xu, C. Wang, Chem 2018, 4, 174-185. [13] Z. Wang, F. Qi, L. Yin, Y. Shi, C. Sun, B. An, H.-M. Cheng, F. Li, Adv. Energy Mater. 2020, 10, 1903843. [14] W. Wang, J. Zhang, Q. Yang, S. Wang, W. Wang, B. Li, ACS Appl. Mater. Interfaces 2020.

Referring to Table 2, it can be seen that the lithium metal batteries using the optimized electrolytes according to the present disclosure exhibit superior cycling performance as compared to the lithium metal batteries using the conventional carbonate-based electrolytes.

1. An electrolyte for a lithium metal battery equipped with a lithium metal anode, comprising:
a lithium salt;
a solvent; and
a diluent comprising 1,2-difluorobenzene.

2. The electrolyte for a lithium metal battery of claim 1, wherein the lithium salt comprises one or more selected from the group consisting of lithium bis(fluorosulfonyl)imide (LiFSI), lithium bis(trifluoromethanesulfonyl)imide (LiTFSI), and lithium hexafluorophosphate (LiPF₆).

3. The electrolyte for a lithium metal battery according to claim 1, wherein the concentration of the lithium salt is 0.5-5.5 M.

4. The electrolyte for a lithium metal battery of claim 1, wherein the solvent comprises one or more selected from the group consisting of dimethyl carbonate (DMC), diethyl carbonate (DEC), ethyl methyl carbonate (EMC), ethylene carbonate (EC), and propylene carbonate (PC).

5. The electrolyte for a lithium metal battery of claim 1, wherein the concentration of the diluent is 30-70 vol %.

6. The electrolyte for a lithium metal battery of claim 1, wherein the diluent forms a solid-electrolyte interphase predominantly comprising lithium fluoride (LiF) on the surface of the lithium metal anode.

7. The electrolyte for a lithium metal battery of claim 1, wherein the diluent forms a local area of high concentration of lithium ions contained in the electrolyte.

8. A lithium metal battery comprising:
a cathode;
a lithium metal anode; and
the electrolyte for a lithium metal battery of claim 1.

9. The lithium metal battery of claim 8,
wherein the cathode further comprises a current collector,
wherein the electrolyte prevents the corrosion of the current collector by forming a solid-electrolyte interphase on the surface of the current collector.

10. A lithium metal battery comprising:
a cathode;
a lithium metal anode; and
the electrolyte for a lithium metal battery of claim 2.

11. The lithium metal battery of claim 10,
wherein the cathode further comprises a current collector,
wherein the electrolyte prevents the corrosion of the current collector by forming a solid-electrolyte interphase on the surface of the current collector.

12. A lithium metal battery comprising:
a cathode;
a lithium metal anode; and
the electrolyte for a lithium metal battery of claim 3.

13. A lithium metal battery comprising:
a cathode;
a lithium metal anode; and
the electrolyte for a lithium metal battery of claim 4.

14. The lithium metal battery of claim 13,
wherein the cathode further comprises a current collector,
wherein the electrolyte prevents the corrosion of the current collector by forming a solid-electrolyte interphase on the surface of the current collector.

15. A lithium metal battery comprising:
a cathode;
a lithium metal anode; and
the electrolyte for a lithium metal battery of claim 5.

16. The lithium metal battery of claim 15,
wherein the cathode further comprises a current collector,
wherein the electrolyte prevents the corrosion of the current collector by forming a solid-electrolyte interphase on the surface of the current collector.

17. A lithium metal battery comprising:
a cathode;
a lithium metal anode; and
the electrolyte for a lithium metal battery of claim 6.

18. The lithium metal battery of claim 17,
wherein the cathode further comprises a current collector,
wherein the electrolyte prevents the corrosion of the current collector by forming a solid-electrolyte interphase on the surface of the current collector.

19. A lithium metal battery comprising:
a cathode;
a lithium metal anode; and
the electrolyte for a lithium metal battery of claim 7.

21. The lithium metal battery of claim 19,
wherein the cathode further comprises a current collector,
wherein the electrolyte prevents the corrosion of the current collector by forming a solid-electrolyte interphase on the surface of the current collector.
